(19) United States
(12) Patent Application Publication
(10) Pub. No.: US 2025/0305756 A1
(43) Pub. Date: Oct. 2, 2025

(54) HANDLE ASSEMBLY FOR AN APPLIANCE DOOR

(71) Applicant: Haier US Appliance Solutions, Inc., Wilmington, DE (US)

(72) Inventor: Jonathan Charles Crosby, Louisville, KY (US)

(21) Appl. No.: 18/620,220

(22) Filed: Mar. 28, 2024

(51) Int. Cl. F25D 23/02; E05B 1/00

(52) U.S. Cl. CPC F25D 23/028; E05B 1/0015

(57) ABSTRACT

A door assembly for an appliance includes a door comprising an outer door panel, a mounting stud extending from the outer door panel along an axial direction, the mounting stud defining an angled contact surface and a catch feature that protrudes along a radial direction from an end of the angled contact surface, a handle tube defining a threaded aperture, and a threaded fastener that passes through the threaded aperture and engages the angled contact surface to secure the handle tube to the door. The mounting stud also defines a reverse chamfer at a distal second end of the mounting stud.

### FIELD OF THE INVENTION

The present subject matter relates generally to domestic appliances, and more particularly, to handle assemblies for domestic appliances.

### BACKGROUND OF THE INVENTION

Domestic appliances (e.g., refrigerators, ovens, microwaves, etc.) typically include doors to open and close certain receiving spaces or drawers. For example, a user may open and close the doors or drawer to facilitate selective access to the interior storage space and easy storage of items. These doors (or drawers) include handles attached thereto which can be grasped and pulled by a user to gain access to the receiving space via the door or drawer. The handles include connection points at which the handle is connected to the appliance (e.g., the door or drawer).

However, with some current handle assemblies, mounting fasteners do not have the geometrical features required to adequately provide feedback to the installer, e.g., regarding whether the handle is properly installed or not. In addition, some fastener designs are more likely to result in a handle mis-assembly condition, e.g., where the set screw does not properly engage the mounting fastener and the handle may not function properly. Finally, some existing fastener designs do not reference the direct handle mating surface, making it difficult to control the position of the fastener in the assembly.

Accordingly, a handle assembly that provides features for improved installation, durability, and reliability is desirable. More specifically, a handle that includes a construction that provides for simple installation with intuitive feedback to the installer as to the success of the handle attachment would be particularly beneficial.

### BRIEF DESCRIPTION OF THE INVENTION

Aspects and advantages of the invention will be set forth in part in the following description, may be apparent from the description, or may be learned through practice of the invention.

In one exemplary embodiment, a door assembly for an appliance is provided including a door comprising an outer door panel, a mounting stud extending from the outer door panel along an axial direction, the mounting stud defining an angled contact surface and a catch feature that protrudes along a radial direction from an end of the angled contact surface, a handle tube defining a threaded aperture, and a threaded fastener that passes through the threaded aperture and engages the angled contact surface to secure the handle tube to the door.

In another exemplary embodiment, a mounting stud for mounting a handle to an appliance door is provided, the mounting stud including a stud body defining an axial direction and a radial direction, a threaded portion defined on a first end of the stud body, the threaded portion being configured for receipt within the appliance door, a reverse chamfer defined at a second end of the stud body, wherein a stud diameter decreases along the reverse chamfer toward the second end of the stud body, and an angled contact surface defined between the threaded portion and the reverse chamfer, wherein the stud diameter increases along the angled contact surface toward the second end of the stud body.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to an example embodiment of the present disclosure.

FIG. 2 provides a top, cross-sectional view of a handle assembly for use with the example refrigerator appliance of FIG. 1 according to an example embodiment of the present disclosure.

FIG. 3 provides a perspective view of a mounting stud of the example handle assembly of FIG. 2 according to an example embodiment of the present subject matter.

FIG. 4 provides a side, cross-sectional view of the example handle assembly of FIG. 2 when properly installed according to an example embodiment of the present disclosure.

FIG. 5 provides a side, cross-sectional view of the example handle assembly of FIG. 2 when improperly installed according to an example embodiment of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

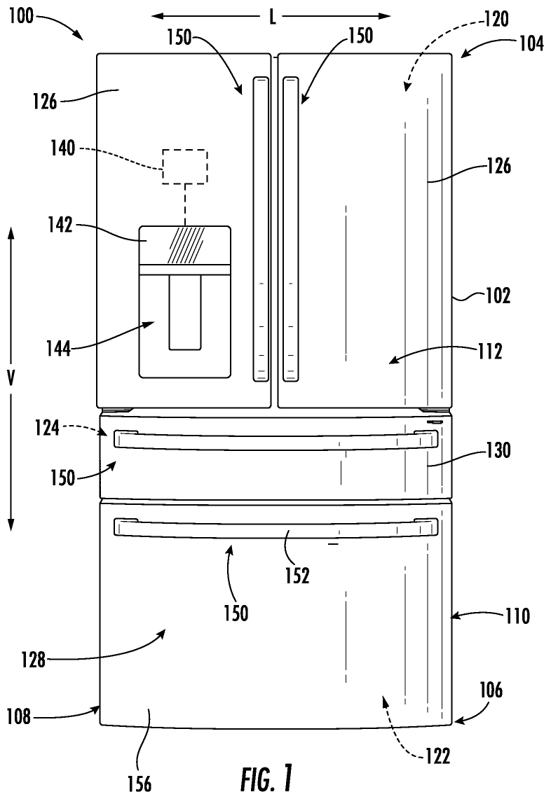

FIG. 1 provides a perspective view of a refrigerator appliance 100 according to an exemplary embodiment of the present subject matter. Refrigerator appliance 100 includes a housing or cabinet 102 that extends between a top 104 and a bottom 106 along a vertical direction V, between a first side 108 and a second side 110 along a lateral direction L, and between a front side 112 and a rear side (not shown) along a transverse direction T. Each of the vertical direction V, lateral direction L, and transverse direction T are mutually perpendicular to one another and form an orthogonal direction system.

Cabinet 102 defines chilled chambers for receipt of food items for storage. In particular, cabinet 102 defines fresh food chamber 120 positioned at or adjacent top 104 of cabinet 102 and a freezer chamber 122 arranged at or adjacent bottom 106 of cabinet 102. An auxiliary food storage chamber 124 may be positioned between the fresh food storage chamber 120 and the freezer chamber 122, e.g., along the vertical direction V. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applicable to any suitable appliance including a handle. Consequently, the description set forth herein is for illustrative purposes only and is not intended to be limiting in any aspect to any particular appliance or configuration.

Refrigerator doors 126 are rotatably hinged to an edge of cabinet 102 for selectively accessing fresh food chamber 120. In addition, a freezer door 128 and an auxiliary door 130 are arranged below refrigerator doors 126 for selectively accessing freezer chamber 122. Freezer door 128 is coupled to a freezer drawer (not shown) slidably mounted within freezer chamber 122. To prevent leakage of cool air, refrigerator doors 126, freezer door 128, auxiliary door 130, and/or cabinet 102 may define one or more sealing mechanisms (e.g., rubber gaskets, not shown) at the interface where the doors 126, 128, 130 meet cabinet 102. It should be appreciated that doors having a different style, position, or configuration are possible within the scope of the present subject matter.

In the exemplary embodiment, cabinet 102 may also define a mechanical compartment (not shown) for receipt of a sealed cooling system (not shown). In general, the sealed cooling system is configured for transporting heat from the inside of refrigerator appliance 100 to the outside (e.g., by executing a vapor-compression cycle or another suitable refrigeration cycle). As is generally understood by those of skill in the art, the hermetically sealed system contains a working fluid, e.g., refrigerant, which flows between various heat exchangers of the sealed system where the working fluid changes phases while transferring thermal energy. Further details regarding the operation of the sealed system are omitted here for brevity.

Operation of the refrigerator appliance 100 can be regulated by a controller 140 that is operatively coupled to a user interface panel 142. User interface panel 142 may provide selections for user manipulation of the operation of refrigerator appliance 100 to modify environmental conditions therein, such as temperature selections, etc. In some embodiments, user interface panel 142 may be proximate a dispenser assembly 144. In response to user manipulation of the user interface panel 142, the controller 140 may operate various components of the refrigerator appliance 100. The controller 140 may regulate operation of various components of the refrigerator appliance 100 in response to programming and/or user manipulation of the user interface panel 142.

The controller 140 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller 140 as disclosed herein is capable of and may be operable to perform any methods and associated method steps as disclosed herein.

The controller 140 may be positioned in a variety of locations throughout refrigerator appliance 100. In the illustrated embodiment, the controller 140 is located within the door 126. In such an embodiment, input/output (“I/O”) signals may be routed between the controller and various operational components of refrigerator appliance 100. In one embodiment, the user interface panel 142 represents a general purpose I/O (“GPIO”) device or functional block. In one embodiment, the user interface 142 includes input components, such as one or more of a variety of electrical, mechanical or electro-mechanical input devices including rotary dials, push buttons, and touch pads. The user interface 142 may include a display component, such as a digital or analog display device designed to provide operational feedback to a user. For example, the user interface 142 may include a touchscreen providing both input and display functionality. The user interface 142 may be in communication with the controller via one or more signal lines or shared communication busses.

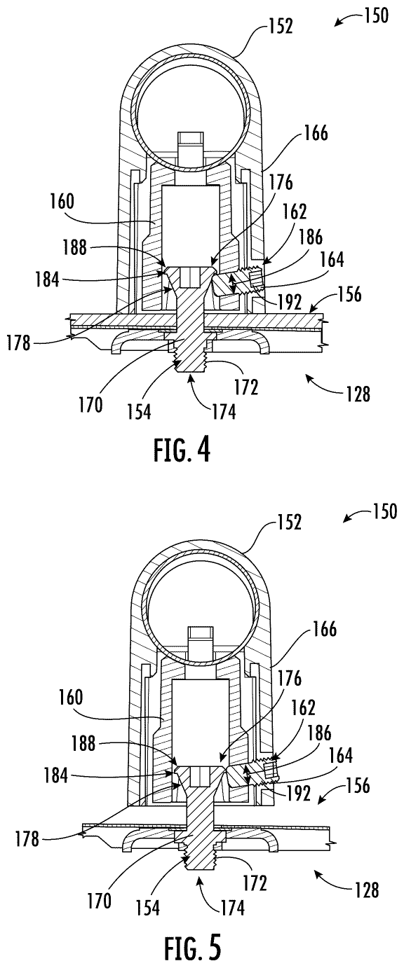

Referring now generally to FIGS. 1 through 5, refrigerator appliance 100 may include one or more handle assemblies 150. For example, a first handle assembly 150 may be attached to freezer door 128, a second handle assembly 150 may be attached to auxiliary door 130, and third and fourth handle assemblies 150 may be attached to refrigerator doors 126. Hereinafter, a single handle assembly 150 will be described in detail in reference to attachment to freezer door 128. It should be understood that the description for handle assembly 150 may apply to one or more handles used to open or close any of the doors or drawers on a domestic appliance (e.g., refrigerator appliance 100).

For instance, with respect to freezer door 128, handle assembly 150 may include a handle tube 152 that is generally oriented in the horizontal position, i.e., parallel to the lateral L direction. In general, handle tube 152 may be a relatively long, slender, generally hollow, tube that is used by a user to grasp handle assembly 150 and manipulate the position of freezer door 128. In this regard, when installed, handle tube 152 may be spaced apart from freezer door 128 such that a user may grasp handle tube 152 to pull open freezer door 128. In the illustrated embodiment, handle tube 152 has a closed, generally trapezoidal cross section. According to some embodiments, handle tube 152 may be cylindrical in cross section, while in others, other closed, generally hollow cross sections may be used. According to the illustrated exemplary embodiment, handle tube 152 may be curved.

According to the illustrated embodiment, refrigerator appliance 100 may include one or more mounting studs 154 to which handle tube 152 may be attached to freezer door 128. More specifically, mounting studs 154 may be embedded within or otherwise secured to freezer door 128 and may extend from an outer door panel 156 forward along the transverse direction T. As illustrated, mounting studs 154 may generally define an axial direction A and a radial direction R that extends perpendicular to the axial direction A, and mounting stud 154 may extend along the axial direction A from outer door panel 156. As described in more detail below, handle assembly 150 may include various features for facilitating attachment of handle tube 152 to mounting studs 154. One of ordinary skill in the art will recognize that the same or substantially similar attachment components may be useful in attaching a handle assembly 150 in different orientations, for example in the vertical V direction (for example, as oriented on refrigerator doors 126).

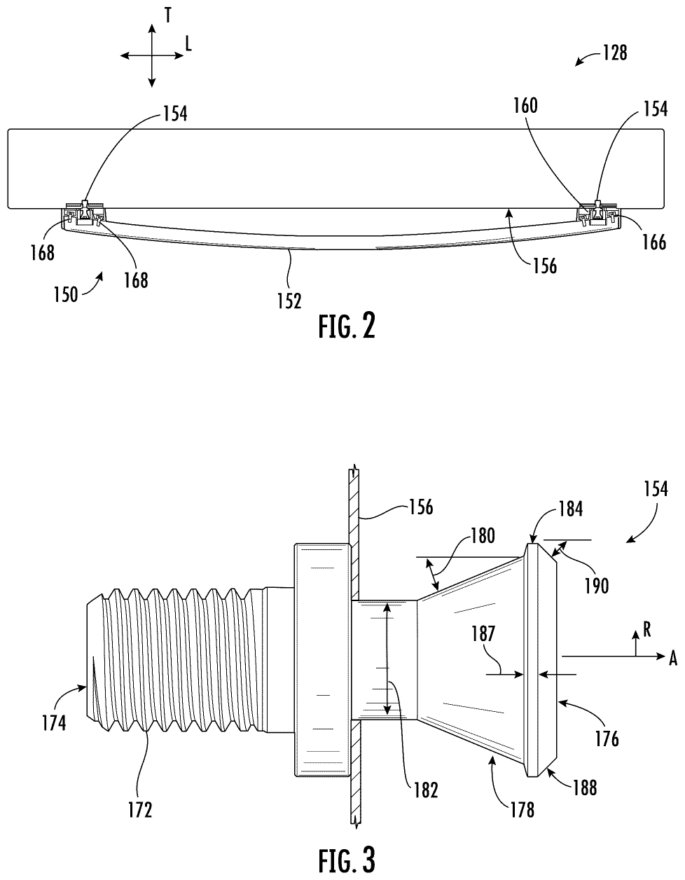

As shown for example in FIGS. 2, 4, and 5, handle assembly 150 may include a bushing 160 that is seated against handle tube 152 and outer door panel 156. According to example embodiments, bushing 160 may define a threaded aperture 162 (e.g., a set screw aperture) that is configured for receiving a threaded fastener 164 (e.g., such as a set screw). To install handle assembly 150, a user may insert threaded fastener 164 into threaded aperture 162 until it engages mounting studs 154 to create a firm engagement and secure handle assembly 150 to freezer door 128, as described in more detail below. It should be appreciated that other attachment methods and fasteners may be used while remaining within the scope of the present subject matter.

According to example embodiments, bushing 160 may further define a through hole (not shown) that is configured for receiving a bushing fastener (not shown) which may extend through the through hole and engage handle tube 152, e.g., via a threaded boss. According to still other embodiments, bushing 160 may be attached to handle tube 152 in any other suitable manner, e.g., via snap fit mechanisms, adhesives, press-fit engagement, mechanical clips, etc. According to other embodiments, bushing 160 may be integrally formed or joined with handle tube 152. Other methods for attaching handle tube 152 and bushing 160 are possible and within the scope of the present subject matter.

For example, referring now specifically to FIG. 2, handle assembly 150 may further include one or more end caps 166 that are generally positioned between outer door panel 156 and handle tube 152. In this manner, end caps 166 may be used to firmly secure handle tube 152 to freezer door 128. In addition, end caps 166 may be configured to conceal or cap the ends of handle tube 152. As shown, one or more cap screws 168 may pass through end caps 166 and may be received within one or more threaded bosses defined in handle tube 152. In this manner, by passing cap screws 168 through end caps 166 and securing them to handle tube 152, a secure mechanical connection may be achieved. According to the illustrated embodiment, two cap screws 168 are positioned on opposite sides of bushing 160 for securing end caps 166, though any other suitable number of screws or fasteners may be used according to alternative embodiments.

In general, handle tube 152, bushing 160, end caps 166, and other components of handle assembly 150 may be formed from any suitably rigid material. For example, handle tube 152 and bushing 160 may be formed from a metal material and end caps 166 may be formed from any suitable plastic material. For example, end caps 166 may be formed by injection molding, e.g., using a suitable plastic material, such as injection molding grade Polybutylene Terephthalate (PBT), Nylon 6, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics.

Referring now specifically to FIGS. 3 through 5, features of mounting stud 154 will be described in more detail according to an example embodiment of the present subject matter. For example, as illustrated, mounting stud 154 may include a stud body 170 that defines the axial direction A in the radial direction R. A threaded portion 172 may be defined on a first end 174 of stud body 170. According to example embodiments, threaded portion 172 is configured for receipt within the freezer door 128, e.g., such that it is fixed relative to outer door panel 156. Notably, when mounting stud 154 is properly attached to freezer door 128, mounting stud 154 extends outward along the axial direction A from outer door panel 156 to a distal end or second end 176.

According to the illustrated embodiment, mounting stud 154 may define an angled contact surface 178 that is configured for engaging threaded fastener 164 to pull handle assembly 150 firmly into contact with outer door panel 156 and secure handle assembly 150 to freezer door 128. As shown, angled contact surface 178 may define a contact angle 180 measured relative to the axial direction A. Contact angle 180 may be designed such that the force exerted by threaded fastener 164 pulls handle assembly 150 onto outer door panel 156. For example, according to an example embodiment, contact angle 180 may be between about 10 and 80°, between about 15 and 45°, or about 20°.

In addition, mounting stud 194 may define a stud diameter 182, measured along the radial direction R. The illustrated embodiment, stud diameter 182 may be smallest at a location where mounting stud 154 engages outer door panel 156 (see FIG. 3). In addition, diameter 182 may be relatively constant for reaching angled contact surface 178. As shown, stud diameter 182 increases along angled contact surface 178 as it approaches second end 176 of stud body 170.

According to the illustrated embodiment, stud body 170 may further define a catch feature 184 that protrudes along the radial direction R from an end of angled contact surface 178. In this regard, catch feature 184 may stand proud of angled contact surface 178, e.g., such that threaded fastener 164 cannot be received fully within threaded aperture 162 if threaded fastener 164 engages catch feature 184. In addition, catch feature 184 may prevent threaded fastener 164 from riding up angled contact surface 178 such that handle assembly 150 would become loose or unsecure. According to the illustrated embodiment, catch feature 184 may generally extend parallel to the axial direction A. In addition, threaded fastener 164 may define a screw diameter 186, and a contact width of contact feature 184 may be less than screw diameter 186, e.g., thereby reducing likelihood that threaded fastener 164 may seat on top of catch feature 184.

According to the illustrated embodiment, mounting stud 154 may further define a reverse chamfer 188 on a distal end or second end 176 of mounting stud 154. In general, reverse chamfer 188 may be designed to completely disengage handle assembly 150 if threaded fastener 164 is seated on reverse chamfer 188, thereby reducing the likelihood of incorrect handle installation. As shown, reverse chamfer 188 may define a chamfer angle 190 measured relative to the axial direction A. Chamfer angle 190 may be designed such that the force exerted by threaded fastener 164 forces handle assembly 150 away from outer door panel 156. For example, according to an example embodiment, chamfer angle 190 may be between about 15 and 60°, between about 30 and 50°, or about 45°. In addition, as illustrated, stud diameter 182 may decrease along reverse chamfer 188 toward second end 176 of stud body 170. As illustrated, catch feature 184 may generally be positioned between angled contact surface 178 and reverse chamfer 188 along the axial direction A.

Notably, according to example embodiments, mounting stud 154 and threaded fastener 164 may be designed such that threaded fastener 164 is fully recessed within threaded aperture 162 when properly installed. In this regard, the length of threaded fastener 164 may be selected such that it is concealed within threaded aperture 162 if threaded fastener 164 engages angled contact surface 178. By contrast, if threaded fastener 164 engages catch feature 184, a portion of threaded fastener 164 may extend out of threaded aperture 162. In addition, threaded fastener 164 may include an indication feature 192 that is visible outside threaded aperture 162 such that a user can see the indication feature 192 when the threaded fastener 164 is not properly installed. For example, indication feature 192 may be a notch or indentation defined on threaded fastener 164. According to still other embodiments, indication feature 192 may be a colored ring or marking on threaded fastener 164. For example, a red marking may provide notice to a user when threaded fastener 164 is not properly installed and is thus protruding from threaded aperture 162 where the red indicator is visible to the user.

As explained herein, aspects of the present subject matter are generally directed to a handle mounting fastener for a refrigerator that is designed with a catch feature to mitigate the risk of handle separation due to a set screw engaging fastener at its sloped contact region. The handle mounting fastener may include a catch feature with a reverse chamfer to reject mis-assembled handles thereby providing visual feedback to the installer of whether or not the handle is mounted correctly onto the door.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A door assembly for an appliance, the door assembly comprising:
a door comprising an outer door panel;
a mounting stud extending from the outer door panel along an axial direction, the mounting stud defining an angled contact surface and a catch protrusion that protrudes along a radial direction from an end of the angled contact surface, wherein the angled contact surface defines a maximum contact diameter at the end of the angled contact surface and the catch protrusion defines a maximum catch diameter, the maximum catch diameter being greater than the maximum contact diameter;
a handle tube defining a threaded aperture; and
a threaded fastener that passes through the threaded aperture and engages the angled contact surface to secure the handle tube to the door.

2. The door assembly of claim 1, wherein the angled contact surface defines a contact angle measured relative to the axial direction, wherein the contact angle is between about 10 and 80 degrees.

3. The door assembly of claim 2, wherein the contact angle is about 20 degrees.

4. The door assembly of claim 1, wherein the mounting stud further defines a reverse chamfer on a distal end of the mounting stud.

5. The door assembly of claim 4, wherein the reverse chamfer defines a chamfer angle measured relative to the axial direction, wherein the chamfer angle is between about 15 and 60 degrees.

6. The door assembly of claim 5, wherein the chamfer angle is about 45 degrees.

7. The door assembly of claim 1, wherein the catch protrusion defines a contact width and the threaded fastener defines a screw diameter, and wherein the contact width is less than the screw diameter.

8. The door assembly of claim 1, wherein the threaded fastener is fully recessed within the handle tube when handle tube is properly installed.

9. The door assembly of claim 1, wherein the threaded fastener has an indication feature visible outside the threaded aperture such that a user can see the indication feature when the threaded fastener is not properly installed.

10. The door assembly of claim 9, wherein the indication feature is a notch or indentation on the threaded fastener.

11. The door assembly of claim 9, wherein the indication feature is a colored ring or marking on the threaded fastener.

12. The door assembly of claim 1, wherein the threaded fastener is a set screw and the threaded aperture is threaded for receipt of the set screw.

13. A mounting stud for mounting a handle to an appliance door, the mounting stud comprising:
a stud body defining an axial direction and a radial direction;
a threaded portion defined on a first end of the stud body, the threaded portion being configured for receipt within the appliance door;
a reverse chamfer defined at a second end of the stud body, wherein a stud diameter decreases along the reverse chamfer toward the second end of the stud body;
an angled contact surface defined between the threaded portion and the reverse chamfer, wherein the stud diameter increases along the angled contact surface toward the second end of the stud body, wherein the angled contact surface defines a maximum contact diameter at the end of the angled contact surface; and
a catch protrusion that protrudes along a radial direction between the angled contact surface and the reverse chamfer, wherein the catch protrusion defines a maximum catch diameter, the maximum catch diameter being greater than the maximum contact diameter.

14. The mounting stud of claim 13, wherein the angled contact surface defines a contact angle measured relative to the axial direction, wherein the contact angle is between about 10 and 80 degrees.

15. The mounting stud of claim 14, wherein the contact angle is about 20 degrees.

16. The mounting stud of claim 13, wherein the reverse chamfer defines a chamfer angle measured relative to the axial direction, wherein the chamfer angle is between about 15 and 60 degrees.

17. The mounting stud of claim 16, wherein the chamfer angle is about 45 degrees.

18. (canceled)

19. The mounting stud of claim 13, wherein the catch protrusion defines a contact width and a threaded fastener defines a screw diameter, and wherein the contact width is less than the screw diameter.

20. The mounting stud of claim 19, wherein the catch protrusion extends parallel to the axial direction.
